(19) United States
(12) Patent Application Publication
(10) Pub. No.: US 2012/0287533 A1
(43) Pub. Date: Nov. 15, 2012

(54) DISK DRIVE SYSTEM WITH AIR DAMPER AND METHOD OF MANUFACTURE THEREOF

(75) Inventors: Chaw-Wu Tseng, San Jose, CA (US); Seungman Chang, Redwood City, CA (US); Shiao-Hua Chen, Palo Alto, CA (US)

(73) Assignee: SEAGATE TECHNOLOGY INTERNATIONAL, Grand Cayman (KY)

(21) Appl. No.: 13/436,834

(22) Filed: Mar. 30, 2012

Related U.S. Application Data
(60) Provisional application No. 61/469,614, filed on Mar. 30, 2011.

(51) Int. Cl. G11B 33/08; G11B 5/10

(52) U.S. Cl. 360/97.13; 29/603.01; G9B/5.034; G9B/33.024

(57) ABSTRACT

A method comprising: providing an arm actuation comprises a lightning hole; and attaching an air damper having a channel on the actuator arm and over the lightning hole, the air damper has the channel from a perimeter of the air damper.

### CROSS REFERENCE TO RELATED APPLICATION

This application claims the benefit of U.S. Provisional Application No. 61/469,614 filed Mar. 30, 2011, the content of which is hereby incorporated by reference in its entirety.

### TECHNICAL FIELD

The invention relates generally to a disk drive system, and more particularly to a system for air damping.

### BACKGROUND ART

A disk drive typically contains one or more disks clamped to a rotating spindle, at least one head for reading data from and/or writing data to the surfaces of each disk, and an actuator for positioning the read/write head(s) over selected data tracks on the disk(s). An actuator is an assembly that couples a slider on which a head is attached or integrally formed to a pivot point that allows the head to sweep across a surface of a rotating disk. Track Mis-Registration (TMR) causes problems for the reading, writing, and reliability of a disk drive.

Thus, a need still remains for a disk system to reduce the Track Mis-Registration. In view of the advances in disk drive technology with ever decreasing spacing between the data tracks, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The invention provides a method of manufacture of a disk drive system including: a lightning hole; and attaching an air damper having a channel on the actuator arm and over the lightning hole, the air damper has the channel from a perimeter of the air damper.

The invention provides a disk drive system including: an arm actuation comprises a lightning hole; and an air damper having a channel on the actuator arm and over the lightning hole, the air damper has the channel from a perimeter of the air damper.

Certain embodiments of the invention have other steps or elements in addition to or in place of those mentioned above. The steps or element will become apparent to those skilled in the art from a reading of the following detailed description when taken with reference to the accompanying drawings.

### BRIEF DESCRIPTION OF THE DRAWINGS

FIG. 1 is a top view of a disk drive system in an embodiment.

FIG. 2 is a top view of the actuator arm with the air damper next to the actuator arm.

FIG. 3 is a top view a portion of the actuator arm with the air damper.

FIG. 4 is an exploded view of the air damper.

FIG. 5 is a graph for the performance improvement of the air damper.

FIG. 6 is a flow chart of a method of operation of the disk drive system.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the invention.

In the following description, numerous specific details are given to provide a thorough understanding of the invention. However, it will be apparent that the invention may be practiced without these specific details. In order to avoid obscuring the invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGS. Similarly, although the views in the drawings for ease of description generally show similar orientations, this depiction in the FIGS. is arbitrary for the most part. Generally, the invention can be operated in any orientation.

For expository purposes, the term “horizontal” as used herein is defined as a plane parallel to the plane or recordable surface of the disk, regardless of its orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane, as shown in the figures. The term “on” means that there is direct contact between elements.

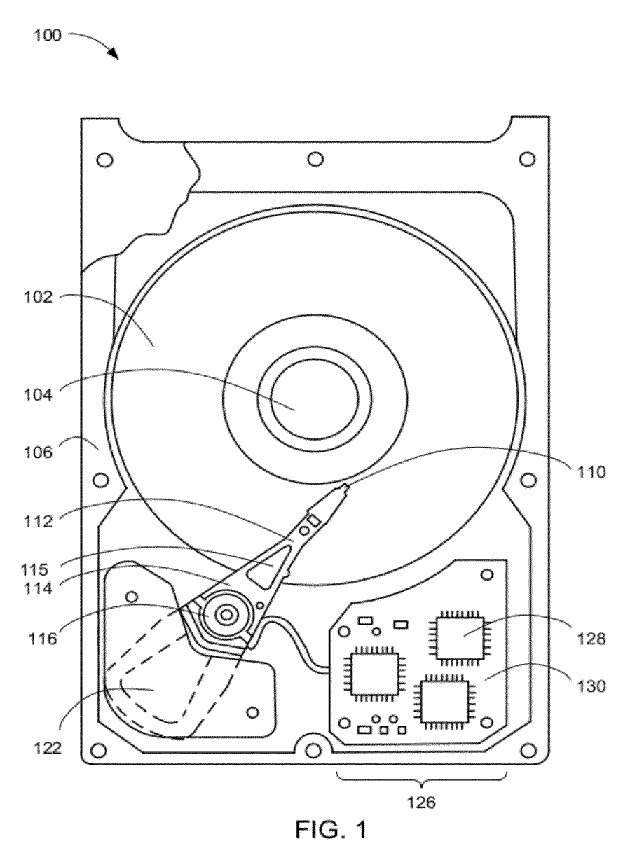

Referring now to FIG. 1, therein is shown a top view of a disk drive system 100 in an embodiment. The top view of the disk drive system 100 depicts a disk 102 that are rotated by a spindle motor 104.

The disk 102 can be made of a light aluminum alloy, ceramic/glass or other suitable substrate, with magnetic material deposited on one or both sides of the disk. The magnetic layer can have tiny domains of magnetization for storing data. The disk can be rotated at a constant or varying rate.

The spindle motor 104 may be mounted to a base plate 106. A head 110 may be gimbal mounted to a flexure arm 112 as part of a head gimbal assembly (HGA). The flexure arm 112 is attached to an actuator arm 114 that is pivotally mounted to the base plate 106 by a bearing assembly 116. The actuator arm 114 can also include an air damper 115. The air damper 115 can suppress arm resonance mode, reduce arm windage to improve track mis-registration (TMR), or a combination thereof.

An actuator, such as voice coil, is attached to the actuator arm 114. The voice coil is coupled to a magnet assembly to create an actuator mechanism, such as voice coil motor (VCM) 122. Providing a current to the voice coil will create a torque that swings the actuator arm 114 and moves a head 110 across the disk 102.

The disk drive system 100 may include a circuit assembly 126 that includes a plurality of integrated circuits 128 coupled to a printed circuit board 130. The circuit assembly 126 is coupled to the VCM 122, the head 110 and the spindle motor 104 by wires (not shown).

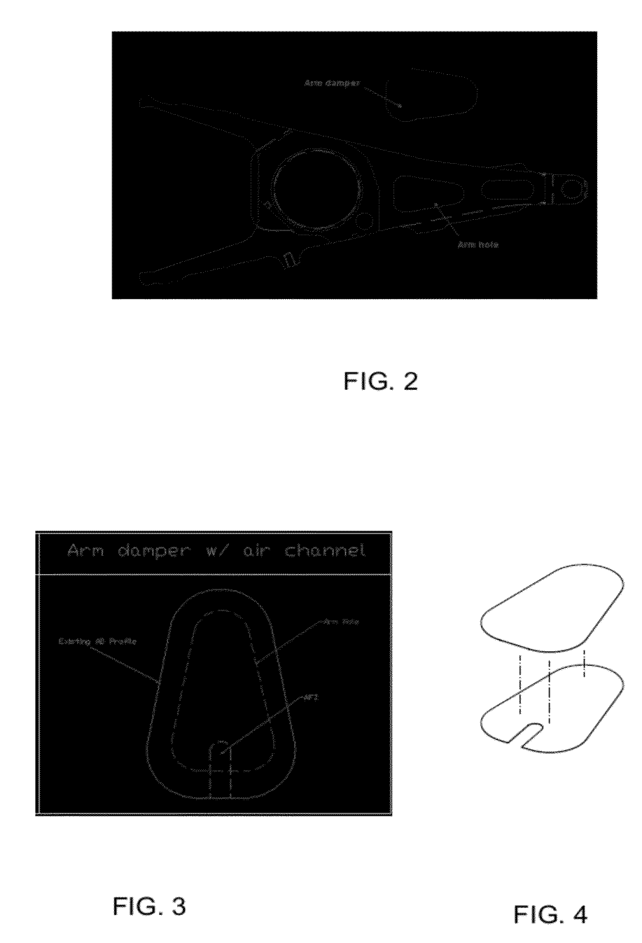

Referring now to FIG. 2, therein is shown a top view of the actuator arm 114 with the air damper 115 next to the actuator arm 114. For example, the actuator arm 114 is depicted with a lightening hole 202. The lighting hole 202 reduces the mass of the actuator arm 114 allowing for the VCM 122 to rapidly accelerate and decelerate the head 110.

The air damper 115 can be placed on the actuator arm 114 and over the lightening hold 202. The air damper 115 can reduce airflow turbulence and dampen mechanical vibration of the actuator arm 114. The airflow turbulence and mechanical vibration can cause position error of the head 110 over the disk 102 of FIG. 1.

Referring now to FIG. 3, therein is shown a top view a portion of the actuator arm 114 with the air damper 115. FIG. 3 depicts the air damper 115 attached to and on the actuator arm 114. The dashed lines depicted within a perimeter of the air damper 115 can represent the boundary of the lightening hole 202.

The air damper 115 can also include a channel 304. The channel 304 is depicted with dashed lines from the perimeter of the air damper 115. The air damper 115 can have the channel 115 extending over the lightening hole 202.

Referring now to FIG. 4, therein is shown an exploded view of the air damper 115. As an example, the exploded view depicts the air damper 115 including a top layer 402 and a lower layer 404. The top layer 402 can be made from any number of materials to help stabilize the actuator arm 114 of FIG. 1. As examples, the top layer 402 can be a stainless steel layer or a tin foil layer. The top layer 402 can include adhesive materials allowing attachment to the lower layer 404.

The lower layer 404 include the channel 304. The lower layer 404 can also be an adhesive layer. The outer perimeter of the top layer 402 and the lower layer 404 can be the same or similar except for the cut out in the lower layer 404 for the channel 304.

It has been discovered that the air damper 115 having the channel 304 allows air venting by the partially adhesive free zone, as in the lower layer 404, which is on the damping adhesive portion of the arm damper 115. This configuration forms a venting channel and resolves the problem of increased position error yet still allows proper air venting to eliminate any possibility of the arm damper 115 being lifted up due to pressure buildup in a hot environmental condition.

It has been also discovered that the location of the channel 304 along the centerline of the arm damper 115 allows for only one design that is needed for both top and bottom side of the lightening hole 202. Also, the channel 304 is away from the head 110 so no DI water would seep during the head stack assembly wash process.

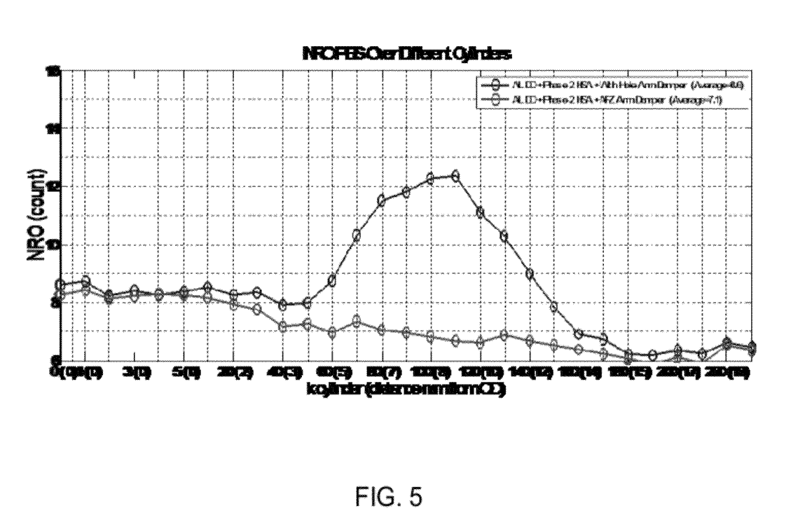

Referring now to FIG. 5, therein is shown a graph for the performance improvement of the air damper 115. FIG. 5 depicts an example performance comparison between the air damper 115 having the channel 304 of FIG. 3 with another air damper (not shown) having a hole (not shown) with the air damper but not extending to the perimeter of that air damper.

The x-axis represents k cylinder (distance from the outer diameter). The y-axis represents the non-repeatable runout. A first plot 502 represents the performance of the air damper having the hole. The first plot 502 is shown to have a peak 504. The second plot 506 represents the performance of the air damper 115 having the channel 304.

A comparison of the first plot 502 and the second plot 506 at the peak 504 depicts that the air damper 115 having the channel 304 reduces the non-repeatable runout count by approximately between 45% to 55%. The air damper 115 having the channel 304 reduces the non-repeatable track mis-registration by 1.5 to 2.0 counts.

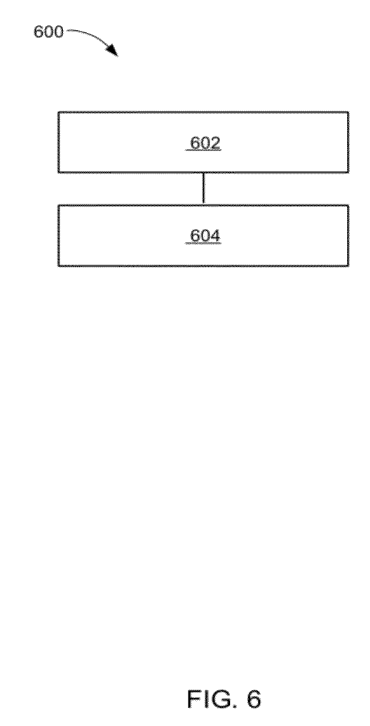

Referring now to FIG. 6, therein is shown a flow chart of a method 600 of manufacture of the disk drive system 100. The method 600 includes: providing an arm actuation comprises a lightning hole in a block 602; and attaching an air damper having a channel on the actuator arm and over the lightning hole, the air damper has the channel from a perimeter of the air damper.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization.

Another important aspect of the invention is that it valuably supports and services the historical trend of reducing costs, simplifying systems, and increasing performance.

These and other valuable aspects of the invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. An method comprising:
providing an arm actuation comprises a lightning hole;
attaching an air damper having a channel on the actuator arm and over the lightning hole, the air damper has the channel from a perimeter of the air damper.

2. The method as claimed in claim 1 further comprising providing the air damper with a top layer and a lower layer, the lower layer comprises the channel.

3. The method as claimed in claim 1 further comprising providing the air damper with an adhesive layer comprises the channel.

4. The method as claimed in claim 1 further comprising:
providing the air damper with a top layer and a lower layer, the lower layer comprised of the channel; and
wherein:
attaching the air damper comprises attaching the air damper with the lower layer having the channel facing the actuator arm.

5. The method as claimed in claim 1 further comprising providing the air damper with the channel along a centerline of the air damper.

6. An apparatus comprising:
an arm actuation comprises a lightning hole;
an air damper having a channel on the actuator arm and over the lightning hole, the air damper has the channel from a perimeter of the air damper.

7. The apparatus as claimed in claim 6 wherein the air damper comprises a top layer and a lower layer, the lower layer comprises the channel.

8. The apparatus as claimed in claim 6 wherein the air damper comprises an adhesive layer comprised of the channel.

9. The apparatus as claimed in claim 6 wherein the air damper comprises:
a top layer; and
a lower layer attached to the top layer, the lower comprised of the channel and facing the actuator arm.

10. The apparatus as claimed in claim 6 wherein the air damper comprises the channel along a centerline of the air damper.
